(19) United States
(12) Patent Application Publication
(10) Pub. No.: US 2020/0025075 A1
(43) Pub. Date: Jan. 23, 2020

(54) Turbocharger And Drive System With Fuel Cell And Turbocharger

(71) Applicant: MAN Energy Solutions SE, Augsburg (DE)

(72) Inventors: Jan-Christoph HAAG, Hirschberg (DE); Lutz Aurahs, Langweid (DE); Christoph Heinz, Langenau (DE); Klaus Bartholomä, Friedberg (DE)

(21) Appl. No.: 16/420,982

(22) Filed: May 23, 2019

(30) Foreign Application Priority Data
May 24, 2018 (DE) DE102018112443.0

(51) Int. Cl. F02C 6/12

(52) U.S. Cl. CPC F02C 6/12; F05D 2220/40

(57) ABSTRACT

A turbocharger, with a turbine for expanding a first medium having a turbine housing and a turbine rotor, a compressor for compressing a second medium utilising energy extracted in the turbine during expansion of the first medium having a compressor housing and a compressor rotor. A temperature of the first medium that is to be expanded or is expanded is lower than a temperature of the second medium that is to be compressed or is compressed. The turbine rotor and the compressor rotor are directly connected to one another.

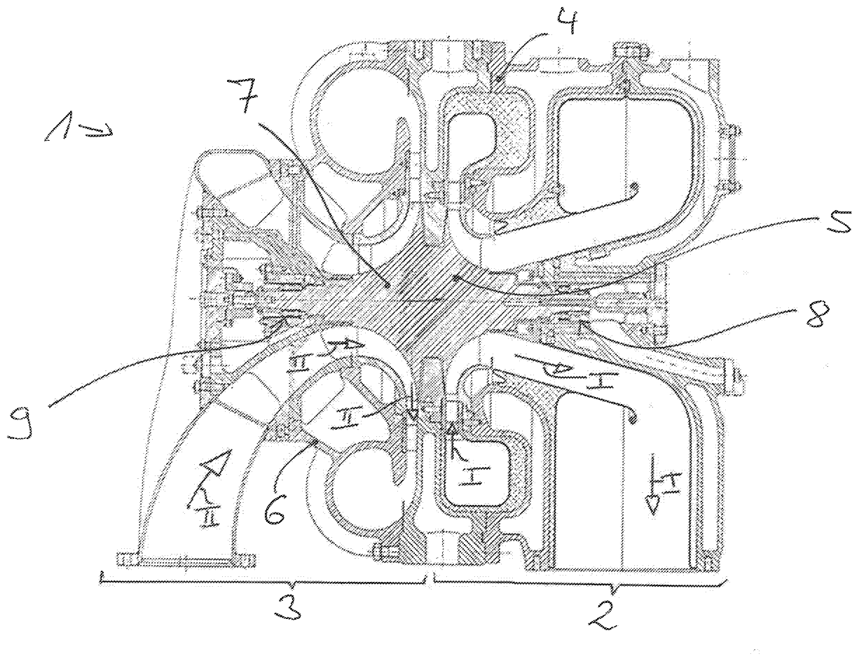

### BACKGROUND OF THE INVENTION

### 1. Field of the Invention

The invention relates to a turbocharger and to a drive system with a fuel cell and a turbocharger.

### 2. Description of the Related Art

The fundamental construction of a turbocharger is known to the person skilled in the art addressed here. A turbocharger comprises a turbine, in which a first medium is expanded, a compressor in which a second medium is compressed, namely utilising the energy extracted in the turbine during the expansion of the first medium. The turbine of the turbocharger comprises a turbine housing and a turbine rotor. The compressor of the turbocharger comprises a compressor housing and a compressor rotor. Between the turbine housing of the turbine and the compressor housing of the compressor a bearing housing is positioned in turbochargers known from practice, wherein the bearing housing is connected on the one side to the turbine housing and on the other side to the compressor housing. In the bearing housing a shaft is mounted via which the turbine rotor is coupled to the compressor rotor.

In turbochargers known from practice, in which the turbine of the turbocharger serves for expanding exhaust gas of an internal combustion engine, in particular a diesel engine or spark-ignition engine, the spacing of turbine rotor and compressor rotor via the shaft and the spacing of compressor housing and turbine housing via the bearing housing is significant to prevent a heat transport emanating from the turbine in the direction of the compressor as much as possible. This serves to avoid that the second medium to be compressed in the compressor is heated through heat transfer or heat conduction emanating from the turbine.

### SUMMARY OF THE INVENTION

One aspect of the present invention is based on the creating a new type of turbocharger and a drive system having such a turbocharger.

The turbocharger according to one aspect of the invention comprises a turbine for expanding a first medium, wherein the turbine comprises a turbine housing and a turbine rotor, a compressor for compressing a second medium utilising energy extracted in the turbine during the expansion of the first medium, wherein the compressor comprises a compressor housing and a compressor rotor, wherein a temperature of the first medium that is to be expanded or is expanded is lower than a temperature of the second medium that is to be compressed or is compressed and wherein the turbine rotor and the compressor rotor are directly connected to one another. The turbine rotor and the compressor rotor are connected to one another without a shaft located in between.

In the turbocharger according to one aspect of the invention, the turbine serves for expanding a medium whose temperature level is below the temperature level in the compressor. The invention is based on the realisation that in such a turbocharger the turbine rotor and the compressor rotor can be directly connected to one another since in this case a heat transfer or heat conduction emanating from the compressor in the direction of the turbine is preferred for increasing the efficiency of the compressor. In this case, a heat coupling between compressor and turbine, which is not desirable in turbochargers known from practice, is especially particularly advantageous so that the turbine rotor and compressor rotor are advantageously connected directly to one another without a shaft located in between.

Preferentially, the turbine is a radial turbine with a turbine rotor subjected to radial inflow and axial outflow, wherein the compressor is a radial compressor with a compressor rotor subjected to an axial inflow and radial outflow, and wherein the turbine rotor and the compressor rotor are positioned back to back and are connected to one another without a shaft located in between. In such a turbocharger with radial turbine and radial compressor, the rotors of which are positioned back to back and coupled without shaft, a heat transfer from the compressor in the direction of the turbine can be particularly advantageously utilised to achieve a high compressor efficiency.

Preferentially, the unit including the turbine rotor and compressor rotor is laterally mounted. At least one first bearing, seen in the flow direction of the first medium, is arranged downstream of the turbine rotor. At least one second bearing, seen in the flow direction of the second medium, is arranged upstream of the compressor rotor. The turbine housing and the compressor housing are connected to one another without a bearing housing located in between. This embodiment is particularly preferred to ensure a compact design of the turbocharger according to one aspect of the invention. Since the compressor rotor and turbine rotor are positioned back to back and connected to one another without a shaft located in between, a bearing housing located between the turbine housing and the compressor housing is omitted. Bearings for mounting the rotors are positioned laterally, i.e. not between compressor rotor and turbine rotor.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

The FIGURE is a cross section through a turbocharger.

### DETAILED DESCRIPTION OF THE PRESENTLY PREFERRED EMBODIMENTS

The invention relates to a turbocharger and to a drive system having a turbocharger.

The FIGURE shows a cross section through a turbocharger 1 according to the invention, wherein the turbocharger 1 comprises a turbine 2 and a compressor 3.

In the turbine 2, a first medium is expanded. Energy extracted in the process is utilised in order to compress a second medium in the compressor 3.

The turbine 2 comprises a turbine housing 4 and a turbine rotor 5. The compressor 3 comprises a compressor housing 6 and a compressor rotor 7.

In the shown preferred exemplary embodiment, the turbine 2 is a radial turbine, the compressor 3 is a radial compressor. The turbine rotor 5 of the turbine 2 is subjected to radial inflow by the first medium to be expanded, wherein expanded first medium axially flows out from the turbine rotor 5 of the turbine 2. Arrows I visualise the flow direction of the first medium, in particular the radial inflow and the axial outflow of the first medium relative to the turbine rotor 5.

The compressor rotor 7 of the radial compressor 3 is subjected to axial inflow by the second medium to be compressed, while compressed second medium in the region of the compressor rotor 7 flows out from the compressor rotor 7 in the radial direction. Arrows II visualise the flow direction of the second medium in the region of the compressor 3, in particular the axial inflow of the compressor rotor 7 and the radial outflow of the compressed second medium from the compressor rotor 7.

The second medium, which is to be compressed or is compressed in the region of the compressor 3, has a higher temperature level than the first medium that is to be expanded or is expanded in the region of the turbine. Accordingly, a temperature of the first medium that is to be expanded or is expanded in the region of the turbine 2 is lower than a temperature of the second medium that is to be compressed or is compressed in the region of the compressor 3.

The compressor rotor 7 and the turbine rotor 5 are directly connected to one another, namely without shaft located in between. In the preferred exemplary embodiment shown in the FIGURE in which the turbine 2 is a radial turbine and the compressor 3 a radial compressor, turbine rotor 5 and compressor rotor 7 are positioned back to back and connected to one another without shaft located in between.

Through this embodiment of the turbocharger, a heat transfer or heat conduction emanating from the compressor 3 in the direction of the turbine 2 is possible, as a result of which the compression efficiency in the region of the compressor 3 can be increased.

Because of the fact that the turbine rotor 5 and the compressor rotor 7 are directly connected to one another without a shaft, a bearing housing between turbine housing 2 and compressor housing 3 is omitted. The mounting of the preferentially monolithical unit consisting of turbine rotor 5 and compressor rotor 7 is effected laterally via bearings 8, 9, wherein at least one first bearing 8, seen in the flow direction of the first medium to be expanded in the region of the turbine 2, is arranged downstream of the turbine rotor 5, and wherein at least one second bearing 9 seen in the flow direction of the second medium to be compressed in the region of the compressor 3 is arranged upstream of the compressor rotor 7. The respective first bearing 8 is integrated in the turbine housing 4, whereas the respective second bearing 9 is integrated in the compressor housing 6.

By omitting a separate bearing housing between turbine housing 2 and compressor housing 3 and by omitting a shaft between turbine rotor 5 and compressor rotor 7, it is not only possible to advantageously utilise the heat transfer from the compressor 3 in the direction of the turbine 2, the installation space requirement of the turbocharger 1 can also be reduced. The turbocharger 1 has a high efficiency, a low weight and a compact design. A further advantage of the arrangement of turbine rotor 5 and compressor rotor 7 according to the invention lies in that wheel lateral spaces on rear sides of turbine rotor 5 and compressor rotor 7 that are present according to practice are eliminated. By way of this, the efficiency can be increased. Because of the pressure conditions on the compressor side and turbine side, an axial thrust. which acts on the unit consisting of turbine rotor 5 and compressor rotor 7, can be minimised. In turbochargers known from practice, this axial thrust has to be absorbed by a bearing, wherein such a bearing results in bearing losses. Such axial thrust-based bearing losses can be minimised in the turbocharger 1 according to one aspect of the invention.

The turbocharger 1 according to one aspect of the invention is part of a drive system which as drive unit includes a fuel cell, in particular a hydrogen-oxygen fuel cell. Exhaust gas of the fuel cell is expanded in the turbine 2 of the turbocharger 1. This exhaust gas is water vapour which has a temperature level below the temperature level in the compressor 3. In the compressor 3 of the turbocharger 1, air is compressed, which is fed to the fuel cell process. As already explained, a good heat conduction emanating from the compressor 3 in the direction of the turbine 2 is possible because of the embodiment of the turbocharger 1. By way of this, the compression efficiency for a drive system with such a turbocharger 1 and a fuel cell can be increased.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed:

1. A turbocharger, comprising:
a turbine configured to expand a first medium, comprising a turbine housing and a turbine rotor; and
a compressor configured to compress a second medium utilising energy extracted in the turbine during expansion of the first medium, comprising a compressor housing and a compressor rotor,
wherein a temperature of the first medium that is to be expanded or is expanded is lower than a temperature of the second medium that is to be compressed or is compressed, and
wherein the turbine rotor and the compressor rotor are directly connected to one another.

2. The turbocharger according to claim 1, wherein:
the turbine is a radial turbine with the turbine rotor subject to radial inflow and axial outflow,
the compressor is a radial compressor with the compressor rotor subject to axial inflow and radial outflow, and
the turbine rotor and the compressor rotor are positioned back to back and directly connected to one another.

3. The turbocharger according to claim 1, wherein the turbine rotor and the compressor rotor are directly connected to one another without a shaft located in between.

4. The turbocharger according to claim 1, wherein a unit consisting of the turbine rotor and the compressor rotor is laterally mounted.

5. The turbocharger according to claim 4, wherein
at least one first bearing, seen in a flow direction of the first medium, is arranged downstream of the turbine rotor, and
at least one second bearing, seen in a flow direction of the second medium, is arranged upstream of the compressor rotor.

6. The turbocharger according to claim 5, wherein
the respective first bearing is integrated in the turbine housing, and
the respective second bearing is integrated in the compressor housing.

7. The turbocharger according to claim 1, wherein the turbine housing is connected to the compressor housing without a bearing housing located in between.

8. A drive system comprising:
a fuel cell; and
a turbocharger, comprising:
a turbine configured to expand a first medium, comprising a turbine housing and a turbine rotor; and
a compressor configured to compress a second medium utilising energy extracted in the turbine during expansion of the first medium, comprising a compressor housing and a compressor rotor,
wherein a temperature of the first medium that is to be expanded or is expanded is lower than a temperature of the second medium that is to be compressed or is compressed, and
wherein the turbine rotor and the compressor rotor are directly connected to one another,
wherein the turbine of the turbocharger expands exhaust gas of the fuel cell as the first medium.
